(19) United States
(12) Patent Application Publication
(10) Pub. No.: US 2009/0122560 A1
(43) Pub. Date: May 14, 2009

(54) LED Mat Light

(76) Inventor: Craig E. Bingham, Arlington, TX (US)

Correspondence Address: CRAIG EARL BINGHAM, 2114 MOSSY OAK ST., ARLINGTON, TX, 76012, US

(21) Appl. No.: 11/937,458

(22) Filed: Nov. 8, 2007

(51) Int. Cl. F21V 15/01; F21V 7/00; F21V 21/00

(52) U.S. Cl. 362/362; 362/310

(57) ABSTRACT

This invention is a method and apparatus for illuminating an area using a generally flat housing containing at least one LED light source emitting a light beam. The housing can be of any size desired, and made of any suitable material. The LED light, or array of LED lights, is contained by the housing which is supplied power using electricity, a battery, transformer or any other type of power source suitable for powering the LED lights. A switch may be between the power source and the lights and will be used for powering the lights on and off.

### FIELD OF THE INVENTION

This invention relates generally to a hands-free work light that is generally flat in nature and may be suspended or laid on the ground to illuminate an area desired.

### SUMMARY OF THE INVENTION

In accordance with the invention there is provided a method and apparatus for illuminating an area using a hands-free work light that is a generally flat housing that can be of any shape or size desired, and made of any suitable material. The housing will be able to be hung on the wall, laid on the floor or suspended in any suitable manner so the light may be energized to illuminate a desired area. The LED light, or array of LED lights, is contained by the housing which is supplied power with said power source suitable for powering the LED lights. A switch may be between the power source and the lights and will be used for powering the lights on and off.

In one embodiment the housing is made of two layers of a soft vinyl material in the shape of a circle, square or rectangle, with reinforced holes every few degrees. An LED light array is attached to the back vinyl material, with a reflective surface between the LED light array and the vinyl. The top layer is a clear vinyl material, allowing the light to shine through the clear vinyl. The power source in this scenario is a wire and transformer that plugs into an electrical wall outlet on one end and the LED light array on the other end, possibly containing a switch in the wire between the transformer and the light.

Another embodiment could be a housing made of rigid plastic in the shape of a rectangle, again with the LED array between the clear layer of plastic and the reflective layer. The plastic housing is hinged in the middle, allowing it to stand on its end on the floor, illuminating the desired area. The power source used is a wire and battery that plugs into the LED light array, possibly containing a switch between the battery and the lights.

### DESCRIPTION OF ILLUSTRATIONS

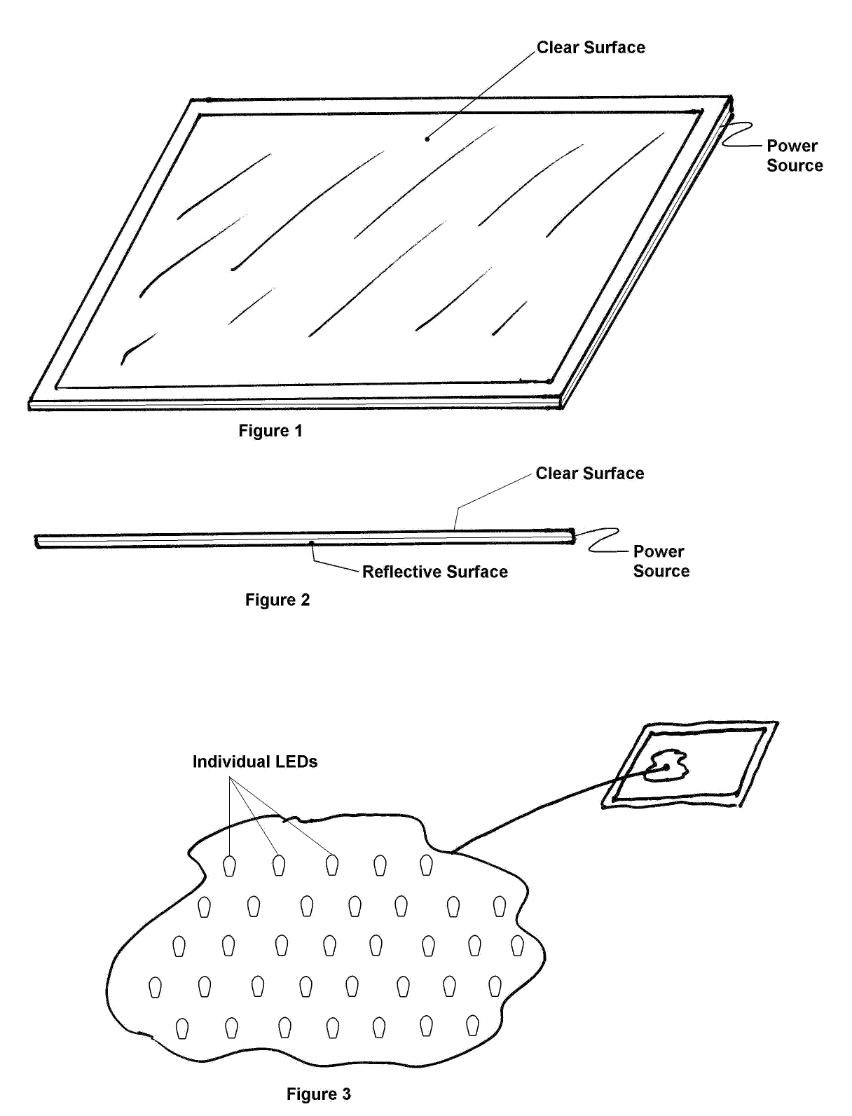

Referring to FIG. 1, a square three dimensional view is presented to depict the general look of the light. The top portion of the light's housing is a clear material, to allow the light to pass through and illuminate an area.

FIG. 2 depicts a side view of the light, showing the reflective lower portion of the housing and the clear upper portion of the housing.

FIG. 3 shows an exploded view of the LED light array contained within the upper and lower parts of the housing. This is simply an array of multiple LED lights that are used to illuminate an area, sandwiched between the upper and lower part of the housing.

While particular embodiments and applications of the invention have been illustrated and described, it is to be understood that the invention is not limited to the precise construction and compositions disclosed herein and that various modifications, changes and variations may be apparent from the foregoing descriptions without departing from the spirit and scope of the invention as defined.

What is claimed is:

1. A method for illuminating an area with a generally flat housing that will be able to be hung on the wall, laid on the floor or suspended in any suitable manner so the LED light may be energized to illuminate a desired area. The LED light, or array of LED lights, is contained by the housing which is supplied power with said power source suitable for powering the LED lights. A switch may be between the power source and the lights and will be used for powering the lights on and off.

2. The method of claim 1 where said light source comprises one or many LED light sources.

3. The method of claim 1 where the light source may be any color LED light source.

4. An apparatus for illuminating an area with a generally flat housing that can be of any shape or size desired, and made of any suitable material. The housing will be able to be hung on the wall, laid on the floor or suspended in any suitable manner so the light may be energized to illuminate a desired area. The LED light, or array of LED lights, is contained by the housing which is supplied power with said power source suitable for powering the LED lights. A switch may be between the power source and the lights and may be used for powering the lights on and off.

5. The apparatus of claim 4 where said light source comprises one or many LED light sources.

6. The apparatus of claim 4 where the light source may be any color LED light source.
